(19) United States
(12) Patent Application Publication
(10) Pub. No.: US 2016/0285952 A1
(43) Pub. Date: Sep. 29, 2016

(54) CONVEYING DATA BETWEEN DEVICES IN WIRELESS PERSONAL AREA NETWORK

(71) Applicant: QUALCOMM Incorporated, San Diego, CA (US)

(72) Inventors: Pradeep PANIGRAHI, Hyderabad (IN); Hemant GUPTA, Hyderabad (IN)

(21) Appl. No.: 14/668,064

(22) Filed: Mar. 25, 2015

(51) Int. Cl. H04L 29/08; H04W 4/00

(52) U.S. Cl. CPC H04L 67/06; H04W 4/008; H04L 67/303

(57) ABSTRACT

Data can be conveyed between devices in a wireless personal area network. At a first device in the wireless personal area network, a request for the data can be received from a second device in the wireless personal area network. The data can be encoded for storage in a computer file using a file format that lacks data compression. A determination can be made whether the second device is configured to decompress the data. The data can be compressed in response to the determination that the second device is configured to decompress the data. The data can be transmitted from the first device to the second device.

### BACKGROUND

1. Field of the Disclosure

Aspects disclosed herein generally relate to conveying data between devices in a wireless personal area network.

2. Description of Related Art

Wireless personal area network technologies take advantage of radio frequencies allocated for low power communications to enable the establishment of short-range wireless networks that can interconnect devices within the personal space of a user. Through such interconnections a user can operate a peripheral component of a personal computing and/or communications system without the need for wired connections between the peripheral component and the personal computing and/or communications system. Additionally, such interconnections facilitate the ability to connect a first device to a larger area network, including the Internet, by establishing a personal area network between the first device and a second device and connecting the second device to the larger area network.

Bluetooth® low energy (or Bluetooth® LE) is a recently developed wireless personal area network technology. As compared with the original Bluetooth® technology, Bluetooth® LE technology is directed to reducing power consumption while maintaining a similar range of communications. The specification requirements of the Bluetooth® LE technology originally were incorporated by the Bluetooth® Special Interest Group into the Bluetooth® Core Version 4.0 specification, which was adopted on Jun. 30, 2010. Several addenda and a supplement to the Core Version 4.0 specification have been adopted since its introduction, most recently the Core Specification Supplement (CSS) v4, which was adopted on Dec. 3, 2013. Also on Dec. 3, 2013, the Special Interest Group adopted the Bluetooth® Core Version 4.1 specification, which includes the requirements of the original Core Version 4.0 specification, its addenda and supplement, and adds new features and benefits.

### SUMMARY

An example aspect can be directed to a method for conveying data between devices in a wireless personal area network. At a first device in the wireless personal area network, a request for the data can be received from a second device in the wireless personal area network. The data can be encoded for storage in a computer file using a file format that lacks data compression. A determination can be made whether the second device is configured to decompress the data. The data can be compressed in response to the determination that the second device is configured to decompress the data. The data can be transmitted from the first device to the second device.

Another example aspect can be directed to a non-transitory computer-readable medium for conveying data between devices in a wireless personal area network. The medium can include computer-readable instructions configured to cause one or more processors to receive, at a first device in the wireless personal area network, a request, from a second device in the wireless personal area network, for the data. The data can be encoded for storage in a computer file using a file format that lacks data compression. The medium can include computer-readable instructions configured to cause the one or more processors to make a determination whether the second device is configured to decompress the data. The medium can include computer-readable instructions configured to cause the one or more processors to compress the data in response to the determination that the second device is configured to decompress the data. The medium can include computer-readable instructions configured to cause the one or more processors to transmit the data from the first device to the second device.

Another example aspect can be directed to a system for conveying data between devices in a wireless personal area network. The system can include a receiver of a first device in the wireless personal area network, a processor of the first device, and a transmitter of the first device. The receiver of the first device can be configured to receive, from a second device in the wireless personal area network, a request for the data. The data can be encoded for storage in a computer file using a file format that lacks data compression. The processor of the first device can be configured to make a determination whether the second device is configured to decompress the data. The processor of the first device can be configured to compress the data in response to the determination that the second device is configured to decompress the data. The transmitter of the first device can be configured to transmit the data to the second device.

Another example aspect can be directed to a system for conveying data between devices in a wireless personal area network. The system can include means for receiving, at a first device in the wireless personal area network, a request, from a second device in the wireless personal area network, for the data. The data can be encoded for storage in a computer file using a file format that lacks data compression. The system can include means for making a determination whether the second device is configured to decompress the data. The system can include means for compressing the data in response to the determination that the second device is configured to decompress the data. The system can include means for transmitting the data from the first device to the second device.

### BRIEF DESCRIPTION OF THE DRAWINGS

These and other sample aspects of the disclosure are described in the detailed description, the appended claims, and the accompanying drawings.

FIG. 1 is a diagram illustrating an example of an environment in which a wireless personal area network can operate.

FIG. 2 is a flow diagram illustrating an example of a method for conveying data between devices in a wireless personal area network.

FIGS. 3 through 5 are flow diagrams illustrating examples of optional operations that can be included in the method illustrated in FIG. 2.

FIG. 6 is a block diagram illustrating an example of a system for conveying data between devices in a wireless personal area network.

FIG. 7 is a diagram illustrating an example of interrelated functional modules that can be included in the first device illustrated in FIG. 6.

FIG. 8 is a diagram illustrating an example of an optional functional module that can be included with the functional modules illustrated in FIG. 7.

FIG. 9 is a flow diagram illustrating another example of a method for conveying data between devices in a wireless personal area network.

FIGS. 10 through 12 are flow diagrams illustrating examples of optional operations that can be included in the method illustrated in FIG. 9.

FIG. 13 is a block diagram illustrating another example of a system for conveying data between devices in a wireless personal area network.

FIG. 14 is a block diagram illustrating an optional component that can be included in the system illustrated in FIG. 13.

FIG. 15 is a diagram illustrating an example of interrelated functional modules that can be included in the second device illustrated in FIG. 13.

FIG. 16 is a diagram illustrating an example of an optional functional module that can be included with the functional modules illustrated in FIG. 15.

In accordance with common practice, the various features illustrated in the drawings may not be drawn to scale. Accordingly, dimensions of the various features may be arbitrarily expanded or reduced for clarity. In addition, aspects illustrated in the drawings may be simplified for clarity. Thus, the drawings may not illustrate all of the components of a given apparatus or device. Finally, like reference numerals may be used throughout the specification and the drawings to denote like features.

### DETAILED DESCRIPTION

Aspects disclosed herein generally relate to conveying data between devices in a wireless personal area network. Alternative aspects may be devised without departing from the scope of this disclosure. Additionally, well-known elements are not described in detail or are omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other alternatives. Likewise, the term “aspect” does not require that all aspects of the disclosure include the discussed feature, advantage, or mode of operation.

The terminology used herein is for the purpose of describing particular aspects only and is not intended to be limiting of aspects of the disclosure. As used herein, the singular forms “a,” “an,” and “the” are intended to include the plural forms as well, unless the context clearly indicates otherwise. It is further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It is recognized that various actions described herein can be performed by specific circuits (e.g., application-specific integrated circuits (ASICs)), by program instructions being executed by one or more processors, or by a combination of both. Additionally, these sequence of actions described herein can be considered to be realized entirely within any form of computer readable storage medium having stored therein a corresponding set of computer instructions that upon execution cause an associated processor to perform the functionality described herein. Thus, the various aspects of the disclosure may be realized in a number of different forms, all of which have been contemplated to be within the scope of the claimed subject matter. In addition, for each of the aspects described herein, the corresponding form of any such aspects may be described herein as, for example, “circuitry configured to” perform the described action.

Wireless personal area network technologies take advantage of radio frequencies allocated for low power communications to enable the establishment of short-range wireless networks that can interconnect devices within the personal space of a user. Through such interconnections a user can operate a peripheral component of a personal computing and/or communications system without the need for wired connections between the peripheral component and the personal computing and/or communications system. Additionally, such interconnections facilitate the ability to connect a first device to a larger area network, including the Internet, by establishing a personal area network between the first device and a second device and connecting the second device to the larger area network.

Several wireless network technologies have been developed and can be used to establish a wireless personal area network. These technologies include, but are not limited to, Bluetooth® technology standards, the ZigBee® specification, Infrared Data Association® (IrD®) specifications, the Wireless USB™ protocol, the Z-Wave® protocol, and Insteon® home automation technology. Through these technologies a wide variety of devices can be interconnected through a wireless personal area network including, but not limited to, a cellular phone, a smartphone, a mobile phone, a hands-free headset, a hands-free car kit, a car stereo system, an intercom, a personal computer, a desktop computer, a laptop computer, a tablet computer, a handheld computer, a personal digital assistant (PDA), a user interface, a mouse, a keyboard, a printer, a scanner, a modem, a hard disk drive, a Universal Serial Bus (USB) flash drive, a digital camera, a global positioning system (GPS) receiver, a media player, a portable media player, a watch, medical equipment, a set-top box, a telehealth device, a bar code scanner, a traffic control device, a robotics system, a game console, a game controller, a tracking node, a tracking tag, a security tag, a light switch, a thermostat, a motion sensor, building access controls, home entertainment systems, household appliances, and other consumer and industrial equipment that are configured to transfer data.

Bluetooth® technology standards were developed as a wireless alternative to serial data communication transmission cables, particularly serial data communication transmission cables configured according to the RS-232 standard. The Bluetooth® Special Interest Group (SIG) is the entity that oversees the development, adoption, and licensing of Bluetooth® technologies. Bluetooth® technologies typically are implemented in a dongle, attachable to a device, or as an integrated circuit within the device. In order to accommodate a wide variety of services, Bluetooth® technologies use targeted specifications, referred to as Bluetooth® profiles, which provide requirements and/or guidelines for particular aspects of Bluetooth®-based communications between devices. Through the use of Bluetooth® profiles, devices that perform particular functions can be configured to include components to support operating in accordance with those Bluetooth® profiles that are relevant to the particular functions. The requirements and/or guidelines of Bluetooth® profiles can be used with the requirements and/or guidelines of one or more of the Bluetooth® core specifications. The requirements and/or guidelines of a Bluetooth® profile can include settings to parametrize and to control communications between devices. Use of Bluetooth® profiles can increase the speed at which a bi-directional link is established between devices. Additionally, Bluetooth® profiles can define possible applications and specify general behaviors that devices can use to communicate with other devices.

The Bluetooth® SIG has adopted several Bluetooth® profiles. For example, the Generic Access Profile (GAP) defines the method by which two Bluetooth® devices locate each other and establish a wireless connection. The Service Discovery Application Profile (SDAP) governs the use of service discovery profiles to detect devices in a wireless network. The Personal Area Network Profile (PAN) addresses formation of an ad-hoc network between devices. The Local Area Network (LAN) Access Profile (LAP) is directed to accessing a device that is connected to an area network.

The Proximity Profile (PXP) addresses monitoring a distance between two devices. The Scan Parameters Profile (ScPP) is directed to sending information about a scanning behavior of a device to a server. The Device Identification Profile (DI) provides information about peripheral devices to a central device. The Subscriber Identity Module (SIM) Access Profile (SAP) governs procedures for accessing subscriber identification information. The Serial Port Profile (SPP) defines the establishment of virtual serial ports between devices. The Time Profile (TIP) is directed to sending information about time. The Synchronization Profile (SYNC) addresses synchronization of calendar and address information.

The Dial-Up Network Profile (DUN) addresses interacting with dial-up services. The Fax Profile (FAX) is directed to interacting with fax software. The Common Integrated Services Digital Network (ISDN) Access Profile (CIP) addresses access to voice, video, data, and other services via the public switched telephone network (PSTN). The Cordless Telephony Profile (CTP) is directed to interactions with cordless telephones.

The File Transfer Profile (FTP) governs transfers of files between a server and a client. The Generic Object Profile (GOEP), the Object Push Profile (OPP), and Object Exchange (OBEX) govern transfers of objects between devices. The Phone Book Aspect Profile (PBAP) is directed to exchange of phone book objects.

The Alert Notification Profile (ANP) supports receiving different types of alerts and event information. The Find Me Profile (FMP) governs sending a location alert signal from a first device and presenting the alert signal at another device. The Phone Alert Status Profile (PASP) governs sending an alert status signal from a phone to a Personal User Interface Device (PUID) (e.g., a watch).

The Hands-Free Profile (HFP) addresses interactions between a gateway device and a hands-free device. The Headset Profile (HSP) addresses interactions between a device and a headset. The Message Access Profile (MAP) defines features to exchange messages between devices. The Human Interface Device Profile (HID) and the Human Interface Device Over GATT Profile (HOGP) are directed to supporting HID services.

The Basic Printing Profile (BPP) and the Hard Copy Cable Replacement Profile (HCRP) are directed to interacting with a printer. The Basic Imaging Profile (BIP) addresses remote control of an imaging device. The Generic Audio/Video Distribution Profile (GAVDP), the Video Distribution Profile (VDP), and the Advanced Audio Distribution Profile (A2DP) are directed to streaming audio data from one device to another. The Audio/Video Remote Control Profile (AVRCP) is directed to interfacing with television sets, high-fidelity equipment, and the like.

The Blood Pressure Profile (BLP) addresses interactions between a device and a blood pressure sensor. The Health Thermometer Profile (HTP) addresses interactions between a device and a thermometer sensor. The Heart Rate Profile (HRP) addresses interactions between a device and a heart rate sensor. The Health Device Profile (HDP) addresses interactions with healthcare and fitness devices.

The Attribute Profile (ATT) and the Generic Attribute Profile (GATT) define methods of organizing data according to their characteristics and the services supported by the data. The Multi Profile Specification (MPS) governs procedures when multiple Bluetooth® profiles are used concurrently.

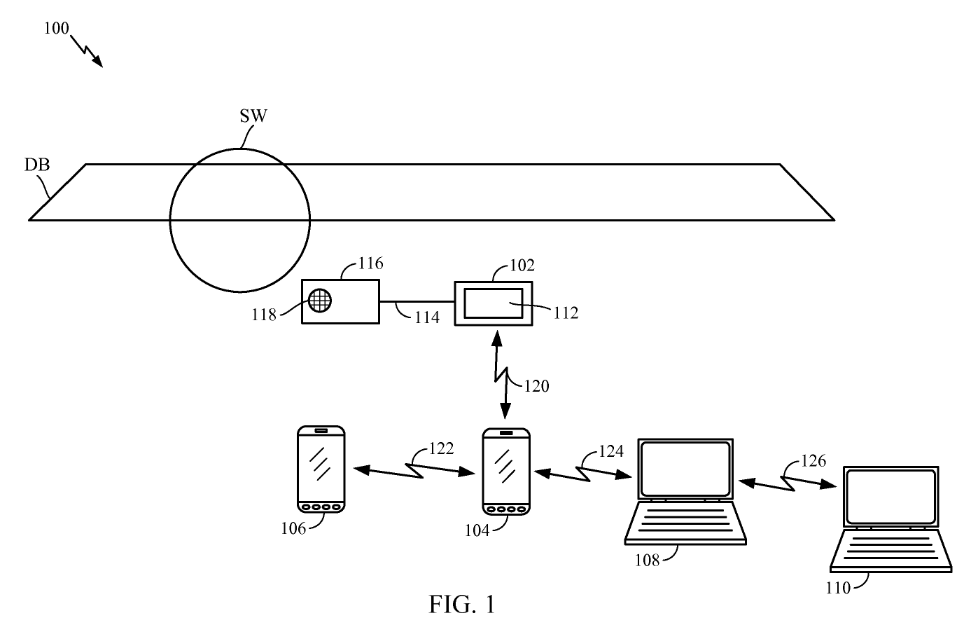

FIG. 1 is a diagram illustrating an example environment in which devices can be interconnected in a wireless personal area network 100. By way of example, and not by way of limitation, the environment illustrated in FIG. 1 can be an interior of an automobile as indicated by a dashboard (DB) and a steering wheel (SW). By way of example, and not by way of limitation, devices that can be interconnected in the wireless personal area network 100 can include a car kit 102, a first mobile phone 104, a second mobile phone 106, a first laptop computer 108, and a second laptop computer 110. The car kit 102 can be, for example, Bluetooth® enabled. The car kit 102 can have, for example, a display screen 112. The car kit 102 can be connected, for example, via a cable 114 to a radio 116 of the automobile. The radio 116 can have a speaker 118. Each of the first mobile phone 104, the second mobile phone 106, the first laptop computer 108, and the second laptop computer 110 can be, for example, Bluetooth® enabled.

For example, if the car kit 102 and the first mobile phone 104 include components to support operating in accordance with the Message Access Profile (MAP), then a message file (e.g., an e-mail message, a text message, or both) received at the first mobile phone 104 can be forwarded through a first Bluetooth® air link 120 to the car kit 102 to be presented visually on the display screen 112, presented audibly through the speaker 118, or both.

For example, if the car kit 102 and the first mobile phone 104 include components to support operating in accordance with the Phone Book Access Profile (PBAP), then a phone book object file stored on the first mobile phone 104 can be transmitted through the first Bluetooth® air link 120 to the car kit 102 to be presented visually on the display screen 112.

For example, if the first mobile phone 104 and the second mobile phone 106 include components to support operating in accordance with the Object Push Profile (OPP), then data stored as an object file (e.g., contact information, appointment information, or the like) on the first mobile phone 104 can be transmitted through a second Bluetooth® air link 122 to the second mobile phone 106. Likewise, for example, if the first mobile phone 104 and the first laptop computer 108 include components to support operating in accordance with the Object Push Profile (OPP), then data stored as an object file (e.g., contact information, appointment information, or the like) on the first mobile phone 104 can be transmitted through a third Bluetooth® air link 124 to the first laptop computer 108.

For example, if the first laptop computer 108 and the second laptop computer 110 include components to support operating in accordance with the File Transfer Profile (FTP), then a file stored on the first laptop computer 108 can be transmitted through a fourth Bluetooth® air link 126 to the second laptop computer 110.

One of skill in the art understands examples of other devices that can be interconnected in the wireless personal area network 100 and the functions that can be performed by these devices dependent upon the Bluetooth® profiles supported by components of these devices. Accordingly, aspects disclosed herein are not limited to the devices and functions illustrated in FIG. 1.

Much of the data stored in the files that are the subjects of the functions described above are encoded using file formats that lack data compression. For example, although the Moving Picture Experts Group (MPEG) MPEG-2 standard Audio Layer III (MP3), the International Telecommunication Union Telecommunication Standardization Sector (ITU-T) standard G.722, the Continuously Variable Slope Delta (CVSD) method, the Windows Media Video (WMV) standard, the MPEG-4 Part 14 standard (MP4), the MPEG-4 Part 10 Advanced Video Coding standard H.264 provide file formats that include data compression, and although the Advanced Audio Distribution Profile (A2DP) includes an algorithm for data compression of audio signals, other file formats, such as the Extensible Markup Language (XML), the American Standard Code for Information Interchange (ASCII) standard, the Universal Character Set Transformation Format—8-bit (UTF-8) scheme, the Multi-Purpose Internet Mail Extensions (MIME) protocol, and text files (.txt), lack data compression.

The lack of data compression in these file formats can undermine the advantages of transmitting files from one device to another device through a Bluetooth® air link. For example, transmitting 1500 kilobytes of data stored in message files encoded using the Extensible Markup Language (XML) format (e.g., approximately 5,000 messages) from a first device to a second device in accordance with the Message Access Profile (MAP) can consume as much as eleven seconds worth of time. In addition to the annoyance that such a wait can elicit from a user of the two devices, such a long period of time can also interrupt the cycling of states prescribed by the Bluetooth® Core standards (e.g., the Bluetooth® Core Version 4.1) so that the devices spend less time in the low power consumption Standby state than the devices would in the absence of such a lengthy transfer process. Reducing the amount of time spent in the Standby state can increase the number of clock cycles of the central processing units of the two devices to be greater than the number of clock cycles would be in the absence of such a lengthy transfer process. Increasing the number of clock cycles can increase the power consumption of both devices to be greater than the power consumption would be in the absence of such a lengthy transfer process. Increasing the power consumption can shorten time durations during which power sources of the devices (e.g., batteries) can provide power to the devices before needing to be charged.

Aspects described herein can alleviate these detriments by compressing data, originally encoded for storage in a computer file using a file format that lacks data compression, prior to transmission to achieve a reduction in the amount of time consumed to transmit files from one device to another device through a Bluetooth® air link. In an aspect, a determination can be made whether the amount of the data is greater than a threshold amount so that compression is performed in a situation in which the added time of performing compression and decompression operations does not exceed the reduction in the amount of time consumed to transmit files achieved by compression. In an aspect, the compression and transmission operations can be repeatedly performed on portions of the data (e.g., on-the-fly compression) until all of the data has been compressed and transmitted. Compression and transmission in this manner can consume less time than compression of all of the data before transmission. In an aspect, reception and the decompression operations can be repeatedly performed on portions of the data (e.g., on-the-fly decompression) until all of the data has been received and decompressed. Reception and decompression in this manner can consume less time than decompression after reception of all of the data.

Advantageously, compressing data, originally encoded for storage in a computer file using a file format that lacks data compression, prior to transmission can achieve a reduction in the amount of time consumed to transmit the data from one device to another device through a Bluetooth® air link. Advantageously, such a reduction in time can allow the cycling of states prescribed by the Bluetooth® Core standards (e.g., the Bluetooth® Core Version 4.1) to proceed at a more normal rate so that the devices spend more time in the low power consumption Standby state. Advantageously, increasing the amount of time spend in the Standby state can decrease the number of clock cycles of the central processing units of the two devices. Advantageously, decreasing the number of clock can decrease the power consumption of both devices. Advantageously, decreasing the power consumption can lengthen time durations during which power sources of the devices (e.g., batteries) can provide power to the devices before needing to be charged.

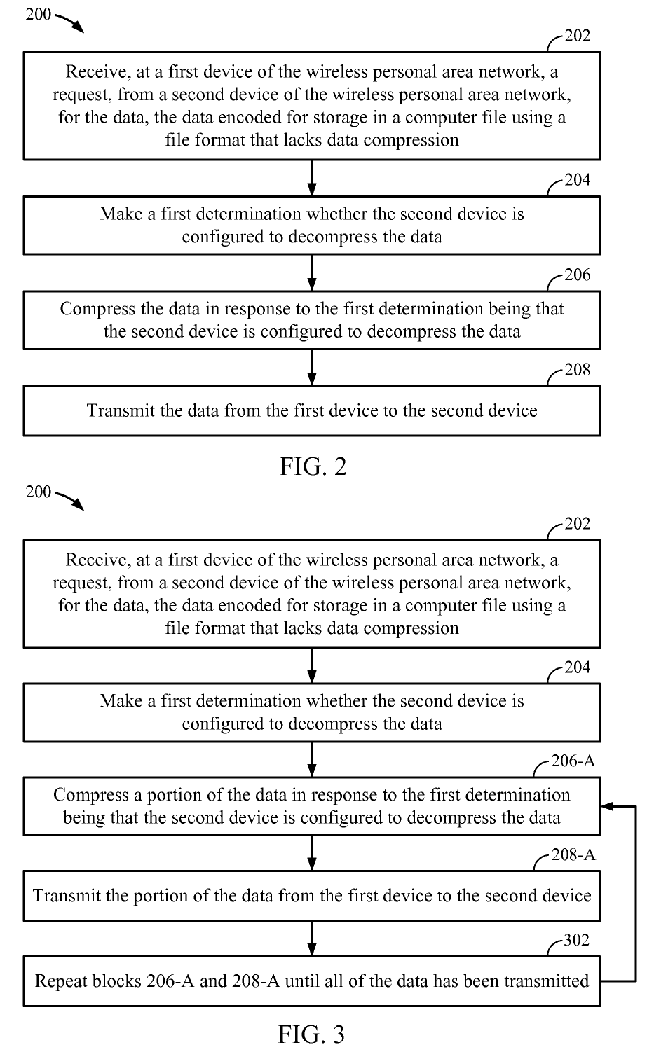

An example aspect can be directed to a method for conveying data between devices in a wireless personal area network. FIG. 2 is a flow diagram illustrating an example of a method 200 for conveying data between devices in a wireless personal area network. In an aspect, the wireless personal area network can comply with a Bluetooth® specification. In the method 200, at a block 202, at a first device in the wireless personal area network, a request for the data can be received from a second device in the wireless personal area network. The data can be encoded for storage in a computer file using a file format that lacks data compression. In an aspect, the file format can include Extensible Markup Language.

In the method 200, at a block 204, a determination can be made whether the second device is configured to decompress the data. In an aspect, the determination can be made during a service discovery operation in which at least one of the first device, the second device, or each of the first device and the second device detects a presence of the other device and determines at least one service supported by the other device. In an aspect, the service discovery operation can be performed in accordance with the Bluetooth® Service Discovery Application Protocol (SDAP). The Bluetooth® Service Discovery Application Protocol (SDAP) specification version 1.1 was adopted on Feb. 22, 2001, was deprecated on Sep. 4, 2014, and is incorporated herein in its entirety by reference. For example, the Bluetooth® Device Identification (DI) Profile specification provides for information about a device to be stored in a Device ID Service Record, which is configured to be fetched during the service discovery operation. Within the Device ID Service Record, different items of information about the device are stored in defined attributes. The Bluetooth® Device Identification (DI) Profile specification version 13, which was adopted on Jul. 26, 2007, and is incorporated herein in its entirety by reference, has reserved attributes 0x0206 through 0x02FF. One of these attributes can be used to identify whether the second device is configured to decompress data in the manner described herein. Alternatively, the ability to decompress data in the manner described herein can be registered as a Bluetooth® service and assigned a universally unique identifier (UUID), which can be referenced during the service discovery operation to determine whether the second device is configured to decompress data in the manner described herein.

In the method 200, at a block 206, the data can be compressed in response to the determination that the second device is configured to decompress the data. In an aspect, by way of example, and not by way of limitation, the data can be compressed using the zlib software library. Information about the zlib software library is found at www.zlib.net. zlib 1.2.8, released Apr. 28, 2013, is the current release. In an aspect, by way of example, and not by way of limitation, the data can be compressed using the gzip software application. Information about the gzip software application is found at www.gzip.org and at www.gnu.org/software/gzip/. In an aspect, the data can be compressed using a combination of the zlib software library and the gzip software application. In the method 200, at a block 208, the data can be transmitted from the first device to the second device.

Applying the method 200 to the scenario described above can achieve a substantial reduction in the amount of time consumed to transmit the data from one device to another device through a Bluetooth® air link. For example, 1500 kilobytes of data stored in message files encoded using the Extensible Markup Language (XML) format (e.g., approximately 5,000 messages) can be compressed, using the gzip software application, to about 90 kilobytes. In this example, the time consumed to compress the data can be about 200 milliseconds, the time consumed to transmit the compressed data from the first device to the second device can be about 600 milliseconds, and the time consumed to decompress the received compressed data can be about 200 milliseconds so that the total time consumed to transmit the data by the method 200 can be about one second.

FIG. 3 is a flow diagram illustrating examples of optional operations that can be included in the method 200. In an aspect, in the method 200, the block 206 can be modified as an optional block 206-A, the block 208 can be modified as an optional block 208-A, and the method 200 can include an optional block 302. At the optional block 206-A, a portion of the data can be compressed. At the optional block 208-A, the portion of the data can be transmitted. At the optional block 302, the operations of the blocks 206-A and 208-A can be repeated (e.g., on-the-fly compression) until all of the data has been transmitted.

For example, as noted in the scenario described above, although compression reduces the time consumed to transmit the data from the first device to the second device from about eleven seconds to about 600 milliseconds, the cost of compression is the time consumed to perform the compression and decompression operations (e.g., about 200 milliseconds for each operation in the scenario described above). In some situations, depending upon the nature of the data to be compressed and the algorithms used for compression and decompression, the time consumed to perform the compression operation in a single instance on all of the data to be transmitted and the time consume to perform the decompression operation in a single instance on all of the data received can be sufficiently long that the total time consumed to transmit the data (e.g., the time consumed to compress the data added to the time consumed to transmit the compressed data added to the time consumed to decompress the received compressed data) is greater than the time consumed simply to transmit the data in an uncompressed form. In some of these situations, the advantage of compression can be achieved by repeatedly performing the compression and transmission operations on portions of the data (e.g., on-the-fly compression) until all of the data has been compressed and transmitted. Compression and transmission in this manner can consume less time than compression of all of the data before transmission. In some of these situations, the advantage of compression can be achieved by repeatedly performing the reception and decompression operations on portions of the data (e.g., on-the-fly decompression) until all of the data has been received and decompressed. Reception and decompression in this manner can consume less time than decompression after reception of all of the data. In some of these situations, the advantage of compression can be achieved through a combination of on-the-fly compression and on-the-fly decompression.

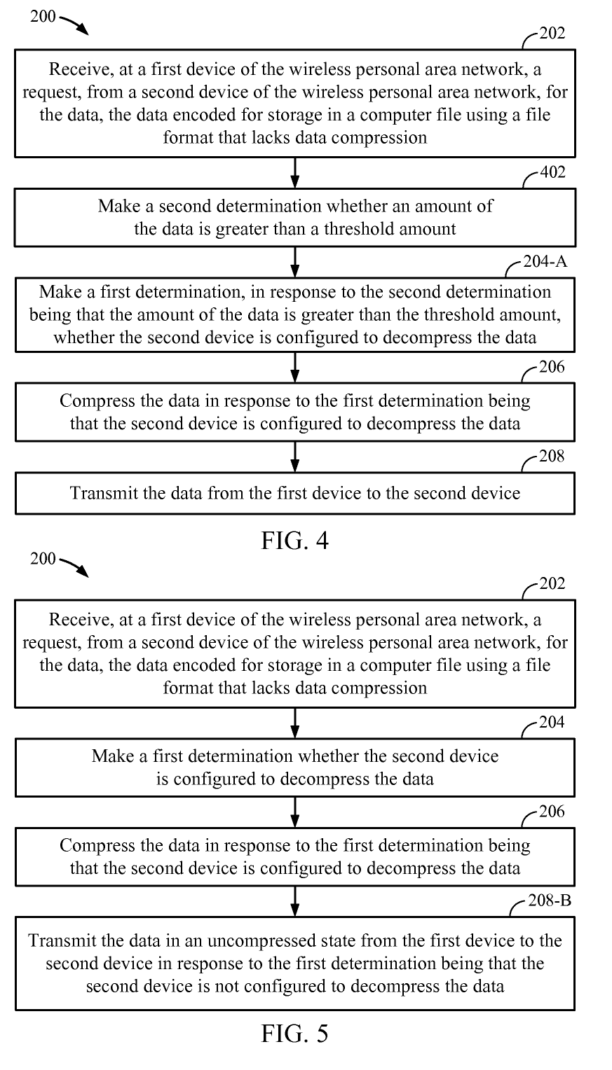

FIG. 4 is a flow diagram illustrating examples of optional operations that can be included in the method 200. In an aspect, in the method 200, the block 204 can be modified as an optional block 204-A and the method 200 can include an optional block 402. At the optional block 402, a determination can be made whether an amount of the data is greater than a threshold amount. At the optional block 204-A, the determination whether the second device is configured to decompress the data can be made in response to the determination that the amount of the data is greater than the threshold amount.

For example, as noted in the scenario described above, although compression reduces the time consumed to transmit the data from the first device to the second device from about eleven seconds to about 600 milliseconds, the cost of compression is the time consumed to perform the compression and decompression operations (e.g., about 200 milliseconds for each operation in the scenario described above). In some situations, depending upon the amount of data to be compressed and the algorithms used for compression and decompression, the time consumed to perform the compression and decompression operations can be sufficiently long that the total time consumed to transmit the data (e.g., the time consumed to compress the data added to the time consumed to transmit the compressed data added to the time consumed to decompress the received compressed data) is greater than the time consumed simply to transmit the data in an uncompressed form.

FIG. 5 is a flow diagram illustrating an example of an optional operation that can be included in the method 200. In an aspect, in the method 200, the block 208 can be modified as an optional block 208-B. At the optional block 208-B, the data can be transmitted in an uncompressed state in response to the determination that the second device is not configured to decompress the data.

Another example aspect can be directed to a non-transitory computer-readable medium for conveying data between devices in a wireless personal area network. In an aspect, the wireless personal area network can comply with a Bluetooth® specification. The medium can include computer-readable instructions configured to cause one or more processors to receive, at a first device in the wireless personal area network, a request, from a second device in the wireless personal area network, for the data. The data can be encoded for storage in a computer file using a file format that lacks data compression. In an aspect, the file format can include Extensible Markup Language.

The medium can include computer-readable instructions configured to cause the one or more processors to make a determination whether the second device is configured to decompress the data. In an aspect, the determination can be made during a service discovery operation in which at least one of the first device, the second device, or each of the first device and the second device detects a presence of the other device and determines at least one service supported by the other device. In an aspect, the service discovery operation can be performed in accordance with the Bluetooth® Service Discovery Application Protocol (SDAP). For example, the Bluetooth® Device Identification (DI) Profile specification provides for information about a device to be stored in a Device ID Service Record, which is configured to be fetched during the service discovery operation. Within the Device ID Service Record, different items of information about the device are stored in defined attributes. The Bluetooth® Device Identification (DI) Profile specification has reserved attributes 0x0206 through 0x02FF. One of these attributes can be used to identify whether the second device is configured to decompress data in the manner described herein. Alternatively, the ability to decompress data in the manner described herein can be registered as a Bluetooth® service and assigned a universally unique identifier (UUID), which can be referenced during the service discovery operation to determine whether the second device is configured to decompress data in the manner described herein.

The medium can include computer-readable instructions configured to cause the one or more processors to compress the data in response to the determination that the second device is configured to decompress the data. In an aspect, by way of example, and not by way of limitation, the data can be compressed using the zlib software library. In an aspect, by way of example, and not by way of limitation, the data can be compressed using the gzip software application. In an aspect, the data can be compressed using a combination of the zlib software library and the gzip software application. The medium can include computer-readable instructions configured to cause the one or more processors to transmit the data from the first device to the second device.

In an aspect, the computer-readable instructions configured to cause the one or more processors to compress the data in response to the determination that the second device is configured to decompress the data can be computer-readable instructions configured to cause the one or more processors to compress a portion of the data in response to the determination that the second device is configured to decompress the data. In this aspect, the computer-readable instructions configured to cause the one or more processors to transmit the data from the first device to the second device can be computer-readable instructions configured to cause the one or more processors to transmit the portion of the data from the first device to the second device. In this aspect, the computer-readable instructions configured to cause the one or more processors to compress the portion of the data and to transmit the portion of the data can be repeated until all of the data has been transmitted.

In an aspect, the medium can include computer-readable instructions configured to cause the one or more processors to make a determination whether an amount of the data is greater than a threshold amount. In this aspect, the computer-readable instructions configured to cause the one or more processors to make the determination whether the second device is configured to decompress the data can be computer-readable instructions configured to cause the one or more processors to make the determination whether the second device is configured to decompress the data in response to the determination that the amount of the data is greater than the threshold amount.

In an aspect, the computer-readable instructions configured to cause the one or more processors to transmit the data from the first device to the second device can be computer-readable instructions configured to cause the one or more processors to transmit the data, in an uncompressed state, from the first device to the second device in response to the determination that the second device is not configured to decompress the data.

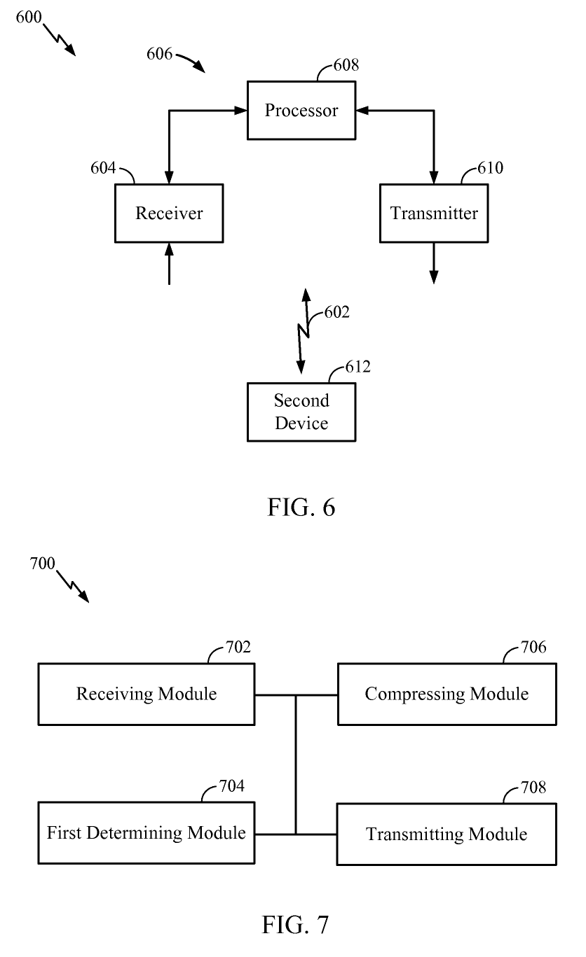

Another example aspect can be directed to a system for conveying data between devices in a wireless personal area network. FIG. 6 is a block diagram illustrating an example of a system 600 for conveying data between devices in a wireless personal area network 602. In an aspect, the wireless personal area network 602 can comply with a Bluetooth® specification. The system 600 can include a receiver 604 of a first device 606 in the wireless personal area network 602, a processor 608 of the first device 606, and a transmitter 610 of the first device 606. The receiver 604 of the first device 606 can be configured to receive, from a second device 612 in the wireless personal area network 602, a request for the data. The data can be encoded for storage in a computer file using a file format that lacks data compression. In an aspect, the file format can include Extensible Markup Language.

The processor 608 of the first device 606 can be configured to make a determination whether the second device 612 is configured to decompress the data. In an aspect, the determination can be made during a service discovery operation in which at least one of the first device 606, the second device 612, or each of the first device 606 and the second device 612 detects a presence of the other device and determines at least one service supported by the other device. In an aspect, the service discovery operation can be performed in accordance with the Bluetooth® Service Discovery Application Protocol (SDAP). For example, the Bluetooth® Device Identification (DI) Profile specification provides for information about a device to be stored in a Device ID Service Record, which is configured to be fetched during the service discovery operation. Within the Device ID Service Record, different items of information about the device are stored in defined attributes. The Bluetooth® Device Identification (DI) Profile specification has reserved attributes 0x0206 through 0x02FF. One of these attributes can be used to identify whether the second device is configured to decompress data in the manner described herein. Alternatively, the ability to decompress data in the manner described herein can be registered as a Bluetooth® service and assigned a universally unique identifier (UUID), which can be referenced during the service discovery operation to determine whether the second device is configured to decompress data in the manner described herein.

The processor 608 of the first device 606 can be configured to compress the data in response to the determination that the second device 612 is configured to decompress the data. In an aspect, by way of example, and not by way of limitation, the data can be compressed using the zlib software library. In an aspect, by way of example, and not by way of limitation, the data can be compressed using the gzip software application. In an aspect, the data can be compressed using a combination of the zlib software library and the gzip software application. The transmitter 610 of the first device 606 can be configured to transmit the data to the second device 612.

In an aspect, the processor 608 of the first device 606 can be configured to compress a portion of the data in response to the determination that the second device 612 is configured to decompress the data. In this aspect, the processor 608 of the first device 606 can be configured to transmit the portion of the data to the second device 612. In this aspect, the processor 608 of the first device 606 can be configured to repeat compression of the portion of the data and transmission of the portion of the data until all of the data has been transmitted.

In an aspect, the processor 608 of the first device 606 can be further configured to make a determination whether an amount of the data is greater than a threshold amount. In this aspect, the processor 608 of the first device 606 can be configured to make the determination whether the second device 612 is configured to decompress the data in response to the determination that the amount of the data is greater than the threshold amount.

In an aspect, the transmitter 610 of the first device 606 can be configured to transmit the data, in an uncompressed state, to the second device 612 in response to the determination that the second device 612 is not configured to decompress the data.

FIG. 7 is a diagram illustrating an example of interrelated functional modules 700 that can be included in the first device 606. The functional modules 700 can include a receiving module 702, a first determining module 704, a compressing module 706, and a transmitting module 708. The receiving module 702 can be configured to receive, at a first device in the wireless personal area network, a request, from a second device in the wireless personal area network, for the data. The data can be encoded for storage in a computer file using a file format that lacks data compression. In an aspect, the file format can include Extensible Markup Language.

The first determining module 704 can be configured to make a determination whether the second device is configured to decompress the data. In an aspect, the determination can be made during a service discovery operation in which at least one of the first device, the second device, or each of the first device and the second device detects a presence of the other device and determines at least one service supported by the other device. In an aspect, the service discovery operation can be performed in accordance with the Bluetooth® Service Discovery Application Protocol (SDAP). For example, the Bluetooth® Device Identification (DI) Profile specification provides for information about a device to be stored in a Device ID Service Record, which is configured to be fetched during the service discovery operation. Within the Device ID Service Record, different items of information about the device are stored in defined attributes. The Bluetooth® Device Identification (DI) Profile specification has reserved attributes 0x0206 through 0x02FF. One of these attributes can be used to identify whether the second device is configured to decompress data in the manner described herein. Alternatively, the ability to decompress data in the manner described herein can be registered as a Bluetooth® service and assigned a universally unique identifier (UUID), which can be referenced during the service discovery operation to determine whether the second device is configured to decompress data in the manner described herein.

The compressing module 706 can be configured to compress the data in response to the determination that the second device is configured to decompress the data. In an aspect, by way of example, and not by way of limitation, the data can be compressed using the zlib software library. In an aspect, by way of example, and not by way of limitation, the data can be compressed using the gzip software application. In an aspect, the data can be compressed using a combination of the zlib software library and the gzip software application. The transmitting module 708 can be configured to transmit the data from the first device to the second device.

In an aspect, the compressing module 706 can be configured to compress a portion of the data in response to the determination that the second device is configured to decompress the data. In this aspect, the transmitting module 708 can be configured to transmit the portion of the data from the first device to the second device. In this aspect, the compressing module 706 and the transmitting module 708 can be configured to repeat compression of the portion of the data and transmission of the portion of the data until all of the data has been transmitted.

In an aspect, the transmitting module 708 can be configured to transmit the data, in an uncompressed state, from the first device to the second device in response to the determination that the second device is not configured to decompress the data.

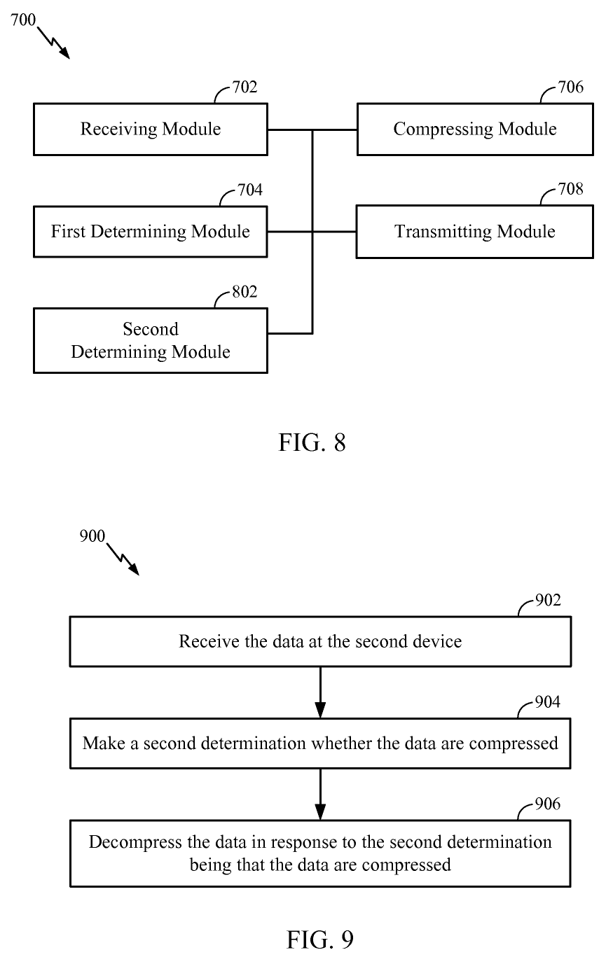

FIG. 8 is a diagram illustrating an example of an optional functional module that can be included with the functional modules 700. In an aspect, the functional modules 700 can include an optional second determining module 802. The second determining module 802 can be configured to make a determination whether an amount of the data is greater than a threshold amount. In this aspect, the first determining module 704 can be configured to make the determination whether the second device is configured to decompress the data in response to the determination that the amount of the data is greater than the threshold amount.

Another example aspect can be directed to a method a method for conveying data between devices in a wireless personal area network. FIG. 9 is a flow diagram illustrating another example of a method 900 for conveying data between devices in a wireless personal area network. In an aspect, the wireless personal area network can comply with a Bluetooth® specification. In the method 900, at a block 902, the data can be received at the second device. In the method 900, at a block 904, a determination can be made whether the data are compressed. In the method 900, at a block 906, the data can be decompressed in response to the determination that the data are compressed. In an aspect, by way of example, and not by way of limitation, the data can be decompressed using the zlib software library. In an aspect, by way of example, and not by way of limitation, the data can be decompressed using the gzip software application. In an aspect, the data can be decompressed using a combination of the zlib software library and the gzip software application.

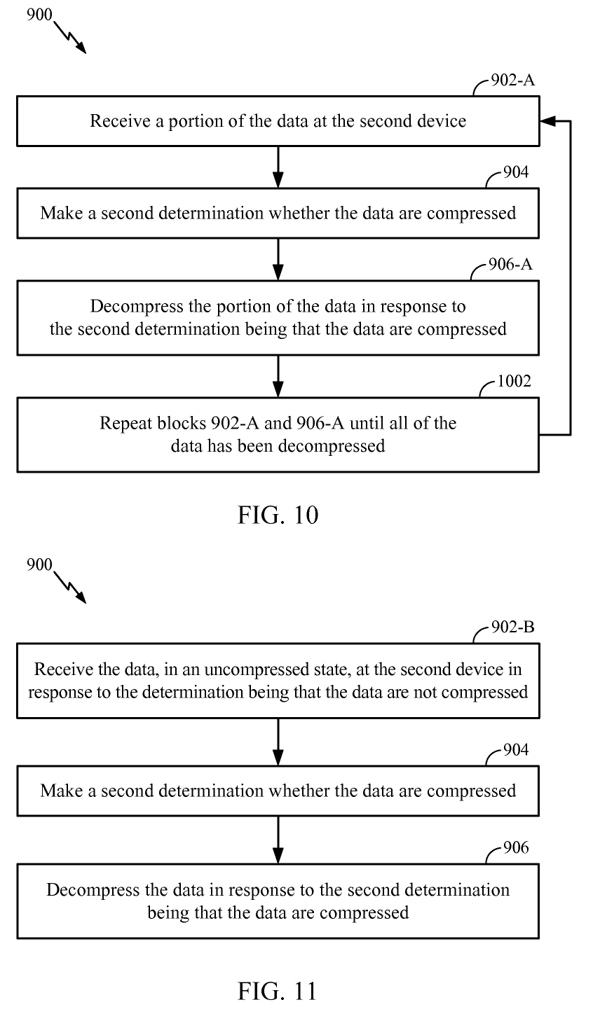

FIG. 10 is a flow diagram illustrating examples of optional operations that can be included in the method 900. In an aspect, in the method 900, the block 902 can be modified as an optional block 902-A, the block 906 can be modified as an optional block 906-A, and the method 900 can include an optional block 1002. At the optional block 902-A, a portion of the data can be received. At the optional block 906-A, the portion of the data can be decompressed. At the optional block 1002, the operations of the blocks 902-A and 906-A can be repeated (e.g., on-the-fly decompression) until all of the data has been decompressed.

FIG. 11 is a flow diagram illustrating an example of an optional operation that can be included in the method 900. In an aspect, in the method 900, the block 902 can be modified as an optional block 902-B. At the optional block 902-B, the data can be received in an uncompressed state in response to the determination that the data are not compressed.

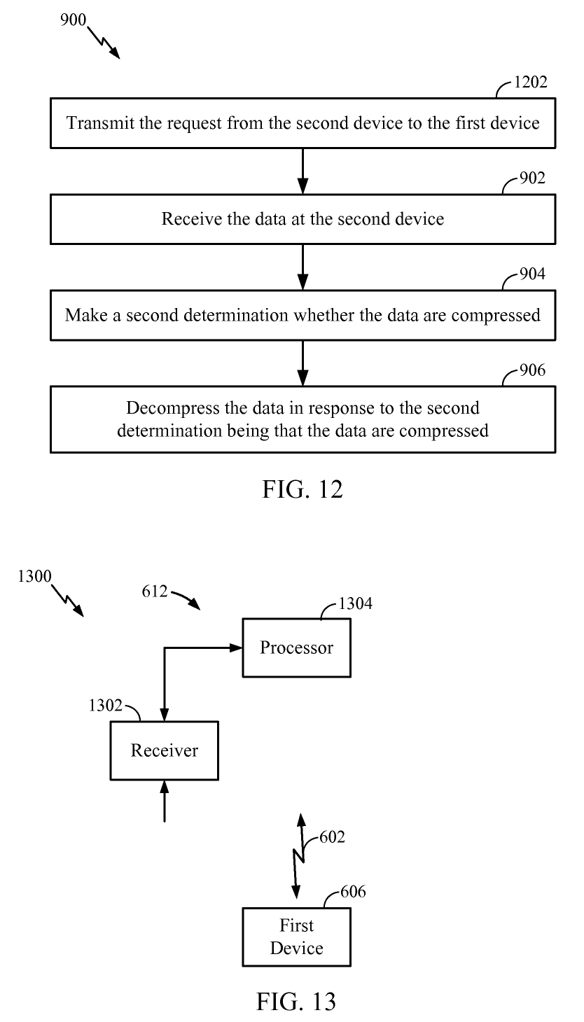

FIG. 12 is a flow diagram illustrating an example of an optional operation that can be included in the method 900. In an aspect, the method 900 can include an optional block 1202. At the optional block 1202, the request can be transmitted from the second device to the first device.

One of skill in the art understands that the method 200 and the method 900 can be combined into a single method in which operations of the method 200 are performed by the first device and operations of the method 900 are performed by the second device.

Another example aspect can be directed to a non-transitory computer-readable medium for conveying data between devices in a wireless personal area network. In an aspect, the wireless personal area network can comply with a Bluetooth® specification. The medium can include computer-readable instructions configured to cause one or more processors to receive the data at the second device. The medium can include computer-readable instructions configured to cause the one or more processors to make a determination whether the data are compressed. The medium can include computer-readable instructions configured to cause the one or more processors to decompress the data in response to the determination that the data are compressed. In an aspect, by way of example, and not by way of limitation, the data can be decompressed using the zlib software library. In an aspect, by way of example, and not by way of limitation, the data can be decompressed using the gzip software application. In an aspect, the data can be decompressed using a combination of the zlib software library and the gzip software application.

In an aspect, the computer-readable instructions configured to cause the one or more processors to receive the data at the second device can be computer-readable instructions configured to cause the one or more processors to receive a portion of the data at the second device. In this aspect, the computer-readable instructions configured to cause the one or more processors to decompress the data in response to the determination that the data are compressed can be computer-readable instructions configured to cause the one or more processors to decompress the portion of the data in response to the determination that the data are compressed. In this aspect, the computer-readable instructions configured to cause the one or more processors to receive the portion of the data and to decompress the portion of the data can be repeated until all of the data has been decompressed.

In an aspect, the computer-readable instructions configured to cause the one or more processors to receive the data at the second device can be computer-readable instructions configured to cause the one or more processors to receive the data in an uncompressed state in response to the determination that the data are not compressed.

In an aspect, the medium can include computer-readable instructions configured to cause the one or more processors to transmit the request from the second device to the first device.

Another example aspect can be directed to a system for conveying data between devices in a wireless personal area network. FIG. 13 is a block diagram illustrating another example of a system 1300 for conveying data between devices in the wireless personal area network 602. In an aspect, the wireless personal area network 602 can comply with a Bluetooth® specification. The system 1300 can include a receiver 1302 of second device 612 in the wireless personal area network 602 and a processor 1304 of the second device 612. The receiver 1302 of the second device 612 can be configured to receive the data. The processor 1304 of the second device 612 can be configured to make a determination whether the data are compressed. The processor 1304 of the second device 612 can be configured to decompress the data in response to the determination that the data are compressed. In an aspect, by way of example, and not by way of limitation, the data can be decompressed using the zlib software library. In an aspect, by way of example, and not by way of limitation, the data can be decompressed using the gzip software application. In an aspect, the data can be decompressed using a combination of the zlib software library and the gzip software application.

In an aspect, the receiver 1302 of the second device 612 can be configured to receive the data in an uncompressed state in response to the determination that the data are not compressed.

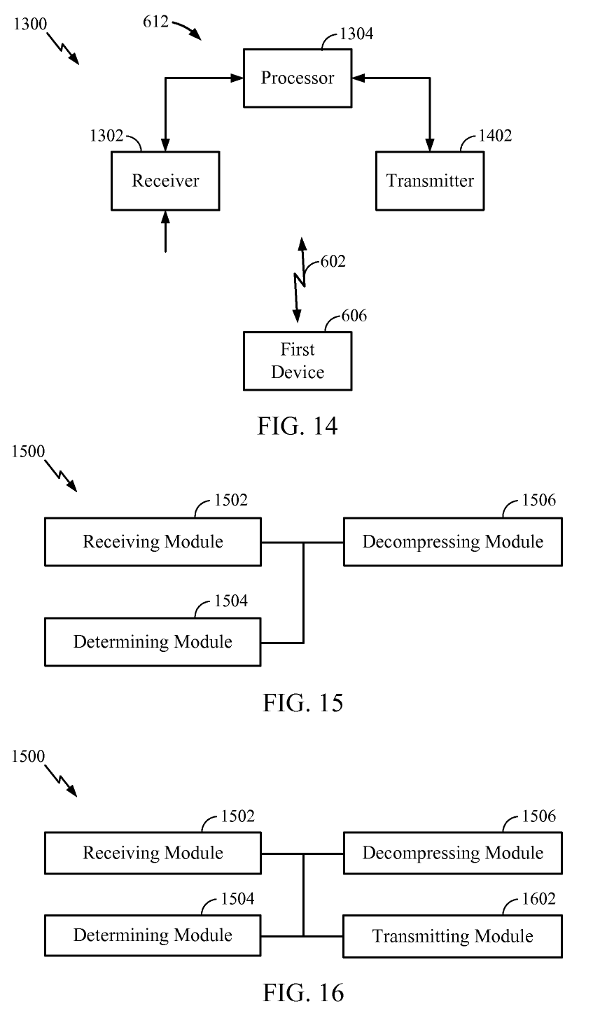

FIG. 14 is a block diagram illustrating an optional component that can be included in the system 1300. In an aspect, the system 1300 can include a transmitter 1402 of the second device 612. The transmitter 1402 of the second device 612 can be configured to transmit the request to the first device 606.

One of skill in the art understands that the system 600 and the system 1300 can be combined into a single system in which operations of the system 600 are performed by the first device 606 and operations of the system 1300 are performed by the second device 612.

FIG. 15 is a diagram illustrating an example of interrelated functional modules that 1500 can be included in the second device 612. The functional modules 1500 can include a receiving module 1502, a determining module 1504, and a decompressing module 1506. The receiving module 1502 can be configured to receive the data at the second device. The determining module 1504 can be configured to make a determination whether the data are compressed. The decompressing module 1506 can be configured to decompress the data in response to the determination that the data are compressed. In an aspect, by way of example, and not by way of limitation, the data can be decompressed using the zlib software library. In an aspect, by way of example, and not by way of limitation, the data can be decompressed using the gzip software application. In an aspect, the data can be decompressed using a combination of the zlib software library and the gzip software application.

In an aspect, the receiving module 1502 can be configured to receive a portion of the data at the second device. In this aspect, the decompressing module 1506 can be configured to decompress the portion of the data in response to the determination that the data are compressed. In this aspect, the receiving module 1502 and the decompressing module 1506 can be configured to repeat reception of the portion of the data and decompression of the portion of the data until all of the data has been decompressed.

In an aspect, the receiving module 1506 can be configured to receive the data in an uncompressed state in response to the determination that the data are not compressed.

FIG. 16 is a diagram illustrating an example of an optional functional module that can be included with the functional modules 1500. In an aspect, the functional modules 1500 can include an optional transmitting module 1602. The transmitting module 1602 can be configured to transmit the request from the second device to the first device.

The functionality of the interrelated modules 700 and/or 1500 can be implemented in various ways consistent with the teachings herein. In some aspects, the functionality of the interrelated modules 700 and/or 1500 can be implemented as one or more electrical components. In some aspects, the functionality of the interrelated modules 700 and/or 1500 can be implemented as a processing system including one or more processor components. In some aspects, the functionality of the interrelated modules 700 and/or 1500 can be implemented using, for example, at least a portion of one or more integrated circuits (e.g., an application-specific integrated circuit (ASIC)). An integrated circuit can include a processor, software, other related components, or some combination thereof. Thus, the functionality of different modules of the interrelated modules 700 and/or 1500 can be implemented, for example, as different subsets of an integrated circuit, as different subsets of a set of software modules, or a combination thereof. Also, one of skill in the art understands that a given subset (e.g., of an integrated circuit and/or of a set of software modules) can provide at least a portion of the functionality for more than one module. As one specific example, the interrelated modules 700 can comprise a single device (e.g., modules 702 through 708 and module 802 comprising different sections of an ASIC). As another specific example, the modules 700 may comprise several devices (e.g., the modules 704 and 802 comprising one ASIC and each of the modules 702, 706, and 708 comprising an ASIC). The functionality of the interrelated modules 700 and/or 1500 also can be implemented in some other manner as taught herein.

In addition, the components and functions represented by the interrelated modules 700 and/or 1500 as well as other components and functions described herein, can be implemented using any suitable means. Such means also can be implemented, at least in part, using corresponding structure as taught herein. For example, the components described above in conjunction with the interrelated modules 700 and/or 1500 also can correspond to similarly designated “means for” functionality. Thus, in some aspects one or more of such means can be implemented using one or more of processor components, integrated circuits, or other suitable structure as taught herein.

Those of skill in the art understand that features described herein with reference to one figure can be interchangeable with features described herein with reference to other figures and that lack of a description of specific feature with reference to a particular figure does not preclude that specific feature from being incorporated into the example of the aspect illustrated by the particular figure.

Those of skill in the art appreciate that information and signals can be represented using any of a variety of different technologies and techniques. For example, data, instructions, commands, information, signals, bits, symbols, and chips that may be referenced throughout the above description can be represented by voltages, currents, electromagnetic waves, magnetic fields or particles, optical fields or particles, or any combination thereof.

Further, those of skill in the art appreciate that the various illustrative logical blocks, modules, circuits, and algorithm operations described in connection with the aspects disclosed herein can be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the aspects disclosed herein.

The various illustrative logical blocks, modules, and circuits described in connection with the implementations disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be realized directly in hardware, in a software module executed by a processor, or in a combination of the two. A software module may reside in random-access memory (RAM), flash memory, read-only memory (ROM), erasable programmable read-only memory (EPROM), electrically erasable programmable read-only memory (EEPROM), registers, a hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable media embodying a method for producing a location history record of a mobile device 108. Accordingly, the disclosure is not limited to illustrated examples and any means for performing the functionality described herein are included in aspects of the disclosure. While the foregoing disclosure shows illustrative aspects of the disclosure, it should be noted that various changes and modifications could be made herein without departing from the scope of the disclosure as defined by the appended claims. The functions, operations and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for conveying data between devices in a wireless personal area network, the method comprising:
receiving, at a first device in the wireless personal area network, a request, from a second device in the wireless personal area network, for the data, the data encoded for storage in a computer file using a file format that lacks data compression;
making a first determination whether the second device is configured to decompress the data;
compressing the data in response to the first determination being that the second device is configured to decompress the data; and
transmitting the data from the first device to the second device.

2. The method of claim 1, wherein the wireless personal area network complies with a Bluetooth® specification.

3. The method of claim 1, wherein the file format comprises Extensible Markup Language.

4. The method of claim 1, wherein the compressing uses at least one of the zlib software library, the gzip software application, or a combination thereof.

5. The method of claim 1, wherein the compressing and the transmitting comprise:
compressing a portion of the data;
transmitting the portion of the data; and
repeating the compressing the portion of the data and the transmitting the portion of the data until all of the data has been transmitted.

6. The method of claim 1, further comprising making a second determination whether an amount of the data is greater than a threshold amount, wherein the making the first determination comprises making the first determination in response to the second determination being that the amount of the data is greater than the threshold amount.

7. The method of claim 1, wherein the transmitting comprises transmitting the data in an uncompressed state in response to the first determination being that the second device is not configured to decompress the data.

8. The method of claim 1, further comprising:
receiving the data at the second device;
making a second determination whether the data are compressed; and
decompressing the data in response to the second determination being that the data are compressed.

9. The method of claim 8, wherein the receiving and the decompressing comprise:
receiving a portion of the data;
decompressing the portion of the data; and
repeating the receiving the portion of the data and the decompressing the portion of the data until all of the data has been decompressed.

10. The method of claim 8, wherein the receiving comprises receiving the data in an uncompressed state in response to the second determination being that the data are not compressed.

11. The method of claim 8, further comprising transmitting the request from the second device to the first device.

12. A non-transitory computer-readable medium for conveying data between devices in a wireless personal area network, the medium comprising computer-readable instructions configured to cause one or more processors to:
receive, at a first device in the wireless personal area network, a request, from a second device in the wireless personal area network, for the data, the data encoded for storage in a computer file using a file format that lacks data compression;
make a first determination whether the second device is configured to decompress the data;
compress the data in response to the first determination being that the second device is configured to decompress the data; and
transmit the data from the first device to the second device.

13. The non-transitory computer-readable medium of claim 12, wherein the wireless personal area network complies with a Bluetooth® specification.

14. The non-transitory computer-readable medium of claim 12, wherein the file format comprises Extensible Markup Language.

15. The non-transitory computer-readable medium of claim 12, wherein the computer-readable instructions configured to cause the one or more processors to compress the data uses the zlib software library, the gzip software application, or a combination thereof.

16. The non-transitory computer-readable medium of claim 12, wherein the computer-readable instructions configured to cause the one or more processors to compress the data and to transmit the data comprise computer-readable instructions configured to cause the one or more processors to:
compress a portion of the data;
transmit the portion of the data; and
repeat the computer-readable instructions configured to cause the one or more processors to compress the portion of the data and the computer-readable instructions configured to cause the one or more processors to transmit the portion of the data until all of the data has been transmitted.

17. The non-transitory computer-readable medium of claim 12, further comprising computer-readable instructions configured to cause the one or more processors to make a second determination whether an amount of the data is greater than a threshold amount, wherein the computer-readable instructions configured to cause the one or more processors to make the first determination comprises computer-readable instructions configured to cause the one or more processors to make the first determination in response to the second determination being that the amount of data is greater than the threshold amount.

18. The non-transitory computer-readable medium of claim 12, wherein the computer-readable instructions configured to cause the one or more processors to transmit the data comprises computer-readable instructions configured to cause the one or more processors to transmit the data in an uncompressed state in response to the first determination being that the second device is not configured to decompress the data.

19. A system for conveying data between devices in a wireless personal area network, the system comprising:
a receiver of a first device in the wireless personal area network, the receiver configured to receive, from a second device in the wireless personal area network, a request for the data, the data encoded for storage in a computer file using a file format that lacks data compression;
a processor of the first device, the processor configured to make a first determination whether the second device is configured to decompress the data, the processor configured to compress the data in response to the first determination being that the second device is configured to decompress the data; and
a transmitter of the first device, the transmitter configured to transmit the data to the second device.

20. The system of claim 19, wherein the wireless personal area network complies with a Bluetooth® specification.

21. The system of claim 19, wherein the processor is further configured to make a second determination whether an amount of the data is greater than a threshold amount, wherein the processor is configured to make the first determination in response to the second determination being that the amount of the data is greater than the threshold amount.

22. The system of claim 19, wherein the transmitter is configured to transmit the data in an uncompressed state in response to the first determination being that the second device is not configured to decompress the data.

23. The system of claim 19, further comprising:
a receiver of the second device, the receiver of the second device configured to receive the data; and
a processor of the second device, the processor of the second device configured to make a second determination whether the data are compressed, the processor of the second device configured to decompress the data in response to the second determination being that the data are compressed.

24. The system of claim 23, wherein the receiver of the second device is configured to receive the data in an uncompressed state in response to the second determination being that the data are not compressed.

25. The system of claim 23, further comprising a transmitter of the second device, the transmitter of the second device configured to transmit the request to the first device.

26. A system for conveying data between devices in a wireless personal area network, the system comprising:
means for receiving, at a first device in the wireless personal area network, a request, from a second device in the wireless personal area network, for the data, the data encoded for storage in a computer file using a file format that lacks data compression;
means for making a first determination whether the second device is configured to decompress the data;
means for compressing the data in response to the first determination being that the second device is configured to decompress the data; and
means for transmitting the data from the first device to the second device.

27. The system of claim 26, wherein the wireless personal area network complies with a Bluetooth® specification.

28. The system of claim 26, further comprising means for making a second determination whether an amount of the data is greater than a threshold amount, wherein the means for making the first determination comprises means for making the first determination in response to the second determination being that the amount of data is greater than the threshold amount.

29. The system of claim 26, further comprising:
means for receiving the data at the second device;
means for making a second determination whether the data are compressed; and
means for decompressing the data in response to the second determination being that the data are compressed.

30. The system of claim 29 further comprising means for transmitting the request from the second device to the first device.
